(19) United States
(12) Patent Application Publication
(10) Pub. No.: US 2006/0222483 A1
(43) Pub. Date: Oct. 5, 2006

(54) Wind turbine for driving a generator

(76) Inventor: Donald S. Seiford SR., Winter Garden, FL (US)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/396,331

(22) Filed: Apr. 3, 2006

Related U.S. Application Data
(60) Provisional application No. 60/594,373, filed on Apr. 1, 2005.

(51) Int. Cl. F03D 7/06

(52) U.S. Cl. 415/4.4

(57) ABSTRACT

The invention is an improved vertical axis wind turbine for driving a generator, and more particularly to such a turbine including a rotor having an improved rotor blade configuration for increased rotational speed and power output. The vertical axis wind turbine generator includes a rotor having a pair of disk-shaped end plates mounted in spaced parallel disposition for rotation about their common axis on a central shaft. A pair of rotor blades are mounted on and extend between the end plates in generally opposed relation to one another and are spaced from the central shaft. Each rotor blade has a generally spoon or ladle shape, including a first generally arcuate substantially semicircular segment, and a second generally arcuate segment curved in a reverse direction. The first segment has a radius R, and the second segment has a substantially longer radius in a range of 2R to 3R. The turbine also includes a stator consisting of a pair of end plates disposed generally parallel to and overlapping the rotor end plates. A plurality of stator vanes are disposed in an annular array around and adjacent to the rotor for concentrating or compressing the moving air mass, or wind, and for redirecting the wind into engagement with the moving rotor blades on one side of the turbine and for deflecting the wind on the opposite side in a conventional manner. This configuration effectively traps the air compressed by the stator vanes over a substantial angle of rotation of the rotor, thereby extracting more energy from the moving air mass. At the same time, as the rotor continues to rotate, the reversely curved second or “handle” segment of the ladle-shaped blade continues to direct the moving air toward the first segment, while air entering the rotor on the following side of the reversely curved handle portion is permitted to pass through the rotor without offering resistance to rotation.

### CROSS-REFERENCE TO RELATED APPLICATIONS

This application is based on U.S. Provisional Application No. 60/594,373 filed on Apr. 1, 2005.

### BACKGROUND OF THE INVENTION

1. Field of the Invention

This invention relates to an improved vertical axis wind turbine for driving a generator, and more particularly to such a turbine including a rotor having an improved rotor blade configuration for increased rotational speed and power output.

2. Description of the Prior Art

Vertical axis wind turbines are known and frequently used to drive rotary devices such as electrical generators. Examples of such known devices may be found, for example, in U.S. Pat. Nos. 6,740,989; 5,852,331; 5,391,926; 4,039,849; 2,812,823; and 588,572. U.S. Pat. No. 6,448,669 discloses a vertical shaft water turbine having a number of structural features similar to those of known wind turbines. The known devices typically include a rotor supported for rotation about a central vertical shaft, with a plurality of curved rotor blades rigidly joined to the shaft or to end plates supported on the shaft for rotation therewith, and a stator structure surrounding the rotor and including a plurality of wind directing vanes for concentrating or compressing the moving air and guiding it onto the rotor vanes in a direction to increase the rotational speed, and consequently the efficiency, of the device.

The rotor blades of the known wind turbines typically have their inner radial edges connected to the turbine shaft, or to a generally cylindrical core member surrounding and spaced from the shaft, with adjacent rotor blades forming air pockets closed at the radially inner ends of the blades and by the end plates. Air concentrated or compressed as it passes through the stator vanes on the upwind side by the turbine is directed into the air pockets of the rotor to drive the rotor about its axis until the air is permitted by the stator vanes to spill out on the downwind side.

It is also known, for example from U.S. Pat. No. 4,039,849, supra, to provide a vertical axis wind turbine with an open center rotor in which the rotor consists of two opposed arcuate rotor blades (referred to in the patent as Savonius blades), mounted in an overlapping S configuration between two disk-shaped end plates, and guide vanes, or “stator” vanes mounted in a circular pattern between the end plates outboard of the rotor vanes for rotation therewith. The guide vanes are mounted for limited pivotal movement and are spring biased in a direction whereby they deflect wind away from the inner rotor blades on one side of the structure and onto the inner vanes on the other side. The guide vanes assist in turning the rotor. The arcuate inner blades are mounted with their concave surfaces generally opposing one another and spaced from the rotor shaft, and each has a first vertical edge spaced from the center axis a distance substantially equal to the radial spacing of the inner edge of the movable vanes, and a second vertical edge positioned radially inward from the movable vanes. The inner and outer vertical edges of both inner blades are illustrated as being located on a common diameter of the rotor.

While numerous prior art vertical axis wind turbines have been used, primarily for driving electrical generators, the efficiency of the known devices generally has been such that they have not met wide spread use despite the abundance of energy available from the wind. Accordingly, it is the primary object of the present invention to provide such a turbine which is economical to construct and which captures a greater amount of energy from the wind passing through the device.

Another object is to provide such a device which is driven at a higher rate of rotation for a given wind speed and which therefore is more efficient in capturing energy from the wind.

Another object is to provide an efficient high speed wind turbine driven generator device.

### SUMMARY OF THE INVENTION

In the attainment of the foregoing objects, an important feature of the invention resides in providing a vertical axis wind turbine generator including a rotor having a pair of disk-shaped end plates mounted in spaced parallel disposition for rotation about their common axis on a central shaft, with a pair of rotor blades mounted on and extending between the end plates in generally opposed relation to one another and spaced from the central shaft. The rotor blades are generally spoon- or ladle-shaped in horizontal cross section, each comprising a first generally arcuate, substantially semicircular segment having a radius R and a second generally arcuate segment having a substantially longer radius, e.g., about 2R to 3R, and being curved in the opposite direction. The radial center of the two curved portions of both rotor blades may be located in a common vertical plane containing the center axis of the end plates and the shaft, whereby the first and second end portions of each blade are joined at the tangent point of the two curved end portions. Preferably the first generally arcuate segment has its free end terminating substantially tangent to the outer circumference of the rotor end plates.

The doubly curved rotor blades arranged substantially as described results in an open air flow path between the two blades, with the spacing between the two blades preferably being a minimum of about R and more preferably about 2R.

Surrounding the rotor is a stator consisting of a pair of end plates disposed generally parallel to and overlapping the rotor end plates, with a plurality of stator vanes disposed in an annular array around and adjacent to the rotor for concentrating or compressing the moving air mass, or wind, and for redirecting the wind into engagement with the moving rotor blades on one side of the turbine and for deflecting the wind on the opposite side in the conventional manner. Preferably the stator includes about six to twelve, and more preferably about eight to ten stator blades disposed in equally spaced relation around the stator. The stator vanes may be flat plates each disposed at an angle of from about 45° to about 60° with respect to a vertical plane containing the vertical axis of the turbine and the radial outer edge of the respective blades.

The ladle-like configuration of the rotor blades enables the first or generally cup-shaped portion of the blade to effectively trap the air compressed by the stator vanes over a substantial angle of rotation of the rotor, thereby extracting more energy from the moving air mass. At the same time, as the rotor continues to rotate, the reversely curved second or “handle” portion of the ladle-shaped blade continues to direct the moving air toward the first portion, while air entering the rotor on the following side of the reversely curved handle portion is permitted to pass through the rotor without offering resistance to rotation. It has been found that, for rotors of the same size and with identical stator configuration, and with winds of the same velocity, the blade configuration described can produce rotation speeds up to about 50% greater than rotors having a conventional rotor blade configuration such as that illustrated, for example, in U.S. Pat. No. 588,572.

An electrical generator may be mounted on the top end plate of the turbine, and driven directly through a shaft coupling or indirectly through a clutch, a redirection gear mechanism or a speed control device, by the rotor shaft. The rotor shaft is supported for rotation about its vertical axis by bearings mounted on the top and bottom end plates or other structural members of the stator.

### BRIEF DESCRIPTION OF THE DRAWINGS

Other features and advantages of the invention will become apparent from the detailed description contained herein below, taken in conjunction with the drawings, in which:

FIG. 1 is an elevation view of a vertical shaft wind turbine embodying the invention and employed to drive an electrical generator; and

FIG. 2 is a sectional view taken along line 2-2 of FIG. 1.

### DESCRIPTION OF THE PREFERRED EMBODIMENT

Referring now to the drawings in detail, a wind turbine driven generator assembly is designated generally by the reference number 10, and includes an electrical generator 12 mounted above a vertical shaft wind turbine 14 including a stator assembly 16 and a rotor assembly 18 for rotation about the common vertical axis 20 of the generator and turbine. The stator 16 includes a circular bottom end plate, or base plate 22 supported by legs 24 above a support surface such as a concrete base slab, and a circular top end plate 26 supported parallel to and spaced above the base plate 22 by a plurality of vertically extending, substantially planar, rectangular guide vanes 28 rigidly joined, as by welding, to the end plates 22, 26. The guide vanes 28 are equally spaced in an annular array around the rotor 18 and are each disposed at an included angle a of from about 45° to about 60° with respect to a vertical plane passing through the vertical axis 20 and the outer vertical edge of the respective vane 28. Each guide vane 28 has its inner vertical edge disposed outboard of and adjacent to the outer periphery of the rotor 16 and its outer vertical edge at the outer periphery of the end plates 22, 26. The stator preferably includes from six to twelve, and more preferably from eight to ten guide vanes 28. A generator support platform 30 is rigidly joined to and projects above the top end plate 26 to support the generator 12 in a manner described below.

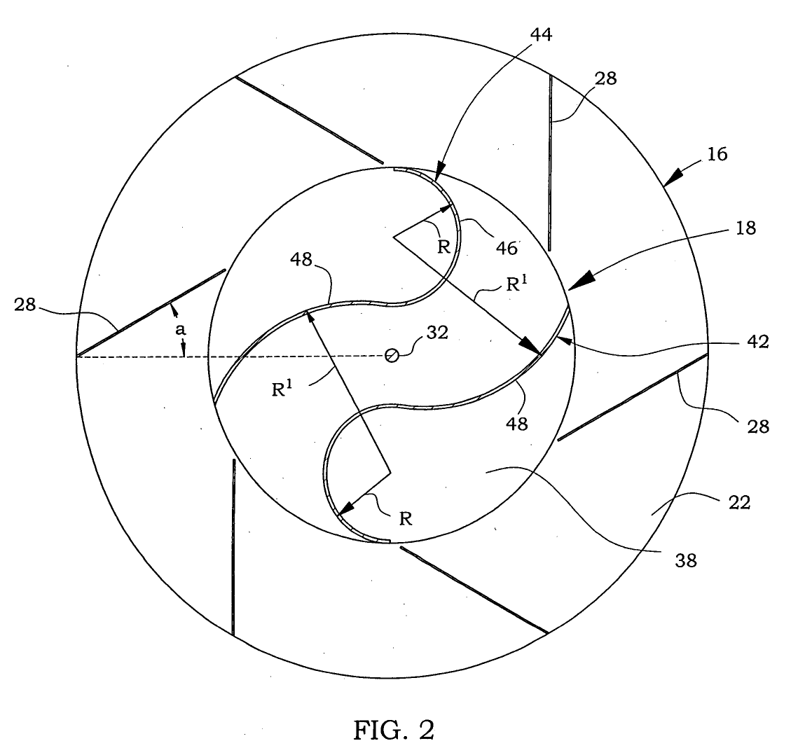

The rotor 18 is mounted for rotation its the vertical axis by a shaft 32 supported by bearings 34, 36 on the bottom and top end plates 22, 26, respectively of the stator 10. The rotor 18 is a rigid welded structure consisting of spaced, circular bottom and top rotor end plates 38, 40 rotatably fixed by suitable means such as by keying, not shown, on the shaft 32 for rotation therewith, and a pair of rotor blades 42, 44 extending between and rigidly welded to the rotor end plates 38, 40. The rotor blades are identical and are each generally ladle-shaped in horizontal cross section and are mounted in opposed relation to one another in spaced relation to the shaft. Each rotor blade 42, 44 comprises a first generally arcuate, substantially semicircular end segment 46 having a radius R and a second generally arcuate, reversely curved end segment 48 having a substantially longer radius R′. The length of R′ is preferably at least about 2 times, and more preferably about 3 times the length of R. The radial centers of both curved segments of each stator blade are preferably located on a single diameter of the rotor whereby the first and second end segments of each rotor blade are tangent at the point of intersection of the two curved segments. Preferably the free ends of the first segments 46 are substantially tangent to the outer circumference of the rotor 18 as seen in FIG. 2.

Also as best seen in FIG. 2, the doubly curved rotor blades arranged as described above provides an open air flow path through the rotor between the opposed second curved segments of the two blades. The spacing of the two rotors in this area is preferably at least about equal to the radius R, and more preferably about two times the length of R.

The ladle-like configuration (in cross section) of the rotor blades enables the first generally “cup-shaped” segment 46 of each blade 42, 44 in succession, to effectively trap the air compressed by the stator blades over a substantial angle of rotation, thereby extracting more energy from the concentrated air flow mass. As the rotor continues to rotate, the leading surface of the reversely curved second, or “handle” segment 48 of that blade continues to direct the moving air toward the first segment while air entering the rotor on the following side of the second segment is permitted to pass through the rotor without offering substantial resistance to rotation until the first segment 46 reaches the point where the air captured by the first segment is permitted to escape through the downwind side of the stator, at which point the wind engages the following surface of the second blade segment moves into position to capture and be propelled by the air mass entering on the upwind side and continues to drive the rotor until the first (cup-shaped) section of the following blade moves into position to capture and be propelled by the air. Also, as air escapes through the open center, suction produced by the venturi effect of the moving air also tends to propel the rotor.

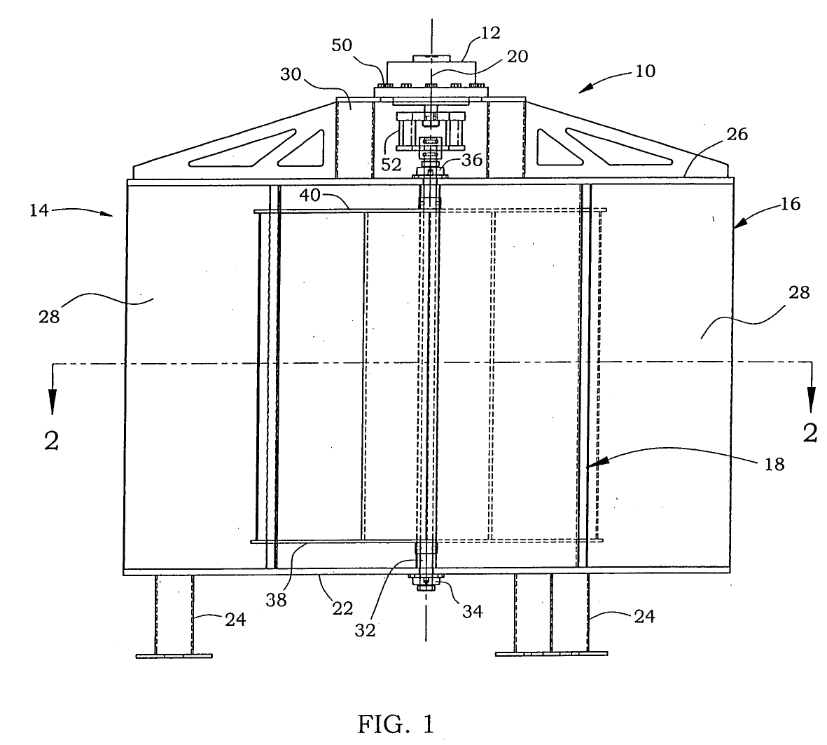

Referring again to FIG. 1, it is seen that the generator 12 is removably mounted, as by bolts 50, on the platform 30 and has its input, or drive shaft 52 coupled by a suitable coupling device 52 to the end of shaft 32 projecting above the top stator end plate 26. The coupling device may include a centrifugal clutch, an overriding clutch, a redirection gear mechanism, or a suitable speed control device, all of which are known and form no part of the invention.

As stated above, it has been found that, for rotors of the same size mounted in identical stators, and with the same wind velocity and air flow mass, an increase in rotor rotation speeds of up to about 50% may be obtained with rotors having a blade configuration as described above over rotors having a conventional rotor blade configuration similar to that illustrated, for example, in U.S. Pat. No. 588,572 or U.S. Pat. No. 6,448,669. While the principle of fluid mechanics which makes this surprising result possible is not fully understood, it is believed that the ability of the doubly curved blade to capture and effectively contain the compressed air in the first “cup-shaped” segment over a greater angle of rotation of the rotor, and the through-flow path on the back side of the blade during this angle of rotation, in combination with the action of the second segment also acting as turbine blade during the subsequent angle of rotation until the cup-shaped segment of the following rotor blade moves into position to capture the air, substantially reduces the rotational resistance produced in conventional rotor designs by incoming wind compressed between successive generally closed rotor packets. The reduced pressure produced by the air flowing over the curved leading surface of the first blade segment is also believed to significantly enhance the efficiency of the rotor.

The foregoing relates to a preferred exemplary embodiment of the invention, it being understood that other variants and embodiments thereof are possible within the spirit and scope of the invention, the latter being defined by the appended claims.

I claim:

1. A vertical axis wind turbine generator comprising:
a rotor having a pair of disk-shaped end plates mounted in spaced parallel disposition for rotation about their common axis on a central shaft;
a pair of rotor blades mounted on and extending between the end plates in generally opposed relation to one another and spaced from the central shaft, each rotor blade having a generally spoon shape in horizontal cross section, comprising a first generally arcuate substantially semicircular segment, and a second generally arcuate segment curved in an opposite direction.

2. A vertical axis wind turbine generator according to claim 1, wherein the first segment has a radius R, and the second segment has a substantially longer radius in a range of 2R to 3R.

3. A vertical axis wind turbine generator according to claim 1, wherein the first segment of each blade has a radial center located in a common vertical plane containing a center axis of the end plates and of the shaft, and wherein the second segment of each blade has a radial center located in the common vertical plane.

4. A vertical axis wind turbine generator according to claim 1, wherein the first segment and the second segment of each rotor blade are joined together at a tangent point at an end of each of the first and second segments opposite a free end of each of the first and second segments.

5. A vertical axis wind turbine generator according to claim 4, wherein the first generally arcuate segment of each rotor blade has its free end terminating substantially tangent to an outer circumference of the rotor end plates.

6. A vertical axis wind turbine generator according to claim 1, wherein an open air flow path is defined by a space between the two blades, the path having a width in a range of R to 2R, where R is the radius of the first segment.

7. A vertical axis wind turbine generator according to claim 1, wherein an open air flow path is defined by a space between the two blades, the path having a width of 2R, where R is the radius of the first segment.

8. A vertical axis wind turbine generator according to claim 1, further comprising a stator consisting of a pair of end plates disposed generally parallel to and overlapping the rotor end plates, with a plurality of stator vanes disposed in an annular array around and adjacent to the rotor for concentrating or compressing the moving air mass, or wind, and for redirecting the wind into engagement with the moving rotor blades on one side of the turbine and for deflecting the wind on the opposite side in a conventional manner.

9. A vertical axis wind turbine generator according to claim 8, wherein the stator includes six to twelve stator vanes disposed in equally spaced relation around the stator.

10. A vertical axis wind turbine generator according to claim 8, wherein the stator includes eight to ten stator vanes disposed in equally spaced relation around the stator.

11. A vertical axis wind turbine generator according to claim 9, wherein the stator vanes may be flat plates each disposed at an angle of 45° to 60° with respect to a vertical plane containing the vertical axis of the turbine and a radial outer edge of the respective vanes.

12. A vertical axis wind turbine generator according to claim 8, further comprising an electrical generator mounted on top of an end plate of the turbine, and driven directly through a shaft coupling or indirectly through a clutch, a redirection gear mechanism or a speed control device, by the rotor shaft.

13. A vertical axis wind turbine generator according to claim 12, wherein the rotor shaft is supported for rotation about its vertical axis by bearings mounted on top and bottom end plates of the turbine.

14. A vertical axis wind turbine generator comprising:
a rotor having a pair of disk-shaped end plates mounted in spaced parallel disposition for rotation about their common axis on a central shaft;
a pair of rotor blades mounted on and extending between the end plates in generally opposed relation to one another and spaced from the central shaft, each rotor blade having a generally spoon shape in horizontal cross section, comprising a first generally arcuate substantially semicircular segment, and a second generally arcuate segment curved in an opposite direction, wherein the first segment has a radius R, and the second segment has a substantially longer radius in a range of 2R to 3R;
a stator consisting of a pair of end plates disposed generally parallel to and overlapping the rotor end plates, with a plurality of stator vanes disposed in an annular array around and adjacent to the rotor for concentrating or compressing the moving air mass, or wind, and for redirecting the wind into engagement with the moving rotor blades on one side of the turbine and for deflecting the wind on the opposite side in a conventional manner.

15. A vertical axis wind turbine generator according to claim 14, wherein the first segment of each blade has a radial center located in a common vertical plane containing a center axis of the rotor and stator end plates and of the shaft, and wherein the second segment of each blade has a radial center located in the common vertical plane.

16. A vertical axis wind turbine generator according to claim 14, wherein the first generally arcuate segment of each rotor blade has its free end terminating substantially tangent to an outer circumference of the rotor end plates.

17. A vertical axis wind turbine generator according to claim 14, wherein an open air flow path is defined by a space between the two blades, the path having a width in a range of R to 2R, where R is the radius of the first segment.

18. A vertical axis wind turbine generator according to claim 14, wherein the stator includes eight to ten stator vanes disposed in equally spaced relation around the stator.

19. A vertical axis wind turbine generator according to claim 14, wherein the stator vanes may be flat plates each disposed at an angle of 45° to 60° with respect to a vertical plane containing the vertical axis of the turbine and a radial outer edge of the respective vanes.

20. A vertical axis wind turbine generator comprising:
a rotor having a pair of disk-shaped end plates mounted in spaced parallel disposition for rotation about their common axis on a central shaft;
a pair of rotor blades mounted on and extending between the end plates in generally opposed relation to one another and spaced from the central shaft, each rotor blade having a generally spoon shape in horizontal cross section, comprising a first generally arcuate substantially semicircular segment, and a second generally arcuate segment curved in an opposite direction, wherein the first segment has a radius R, and the second segment has a substantially longer radius in a range of 2R to 3R;
a stator consisting of a pair of end plates disposed generally parallel to and overlapping the rotor end plates, with a plurality of stator vanes disposed in an annular array around and adjacent to the rotor for concentrating or compressing the moving air mass, or wind, and for redirecting the wind into engagement with the moving rotor blades on one side of the turbine and for deflecting the wind on the opposite side in a conventional manner; and
an electrical generator mounted on top of an end plate of the turbine, and driven directly through a shaft coupling or indirectly through a clutch, a redirection gear mechanism or a speed control device, by the rotor shaft.
